(19) United States
(12) Patent Application Publication
(10) Pub. No.: US 2026/0195589 A1
(43) Pub. Date: Jul. 9, 2026

(54) USING PRUNED NEURAL NETWORKS FOR ENERGY REDUCTION

(71) Applicant: INTERNATIONAL BUSINESS MACHINES CORPORATION, ARMONK, NY (US)

(72) Inventors: ANDREW CHRISTIAN MORRELL HICKS, HIGHLAND, NY (US); JEFFREY WILLOUGHBY, POUGHKEEPSIE, NY (US); KHAALID PERSAUD JUGGAN MCMILLAN, HAVERSTRAW, NY (US)

(21) Appl. No.: 19/011,014

(22) Filed: Jan. 6, 2025

(51) Int. Cl. G06N 3/082

(52) U.S. Cl. CPC G06N 3/082

(57) ABSTRACT

Using pruned neural networks for energy reduction, including: receiving a command to reduce an energy usage of a neural network; transitioning, in response to the command, from using a particular version of the neural network to using a pruned version of the neural network, wherein the pruned version of the neural network comprises a subset of a plurality of layers of the particular version of the neural network; and performing one or more inference operations using the pruned version of the neural network.

### BACKGROUND

The present disclosure relates to methods, apparatus, and products for using pruned neural networks for energy reduction.

### SUMMARY

According to embodiments of the present disclosure, various methods, apparatus and products for using pruned neural networks for energy reduction are described herein. In some aspects, using pruned neural networks for energy reduction includes receiving a command to reduce an energy usage of a neural network; transitioning, in response to the command, from using a particular version of the neural network to using a pruned version of the neural network, wherein the pruned version of the neural network comprises a subset of a plurality of layers of the particular version of the neural network; and performing one or more inference operations using the pruned version of the neural network. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth a diagram of an example computing environment for using pruned neural networks for energy reduction in accordance with some embodiments of the present disclosure.

FIG. 2 sets forth a flowchart of an example method for using pruned neural networks for energy reduction in accordance with some embodiments of the present disclosure.

FIG. 3 sets forth a flowchart of another example method for using pruned neural networks for energy reduction in accordance with some embodiments of the present disclosure.

FIG. 4 sets forth a flowchart of another example method for using pruned neural networks for energy reduction in accordance with some embodiments of the present disclosure.

FIG. 5 sets forth a flowchart of another example method for using pruned neural networks for energy reduction in accordance with some embodiments of the present disclosure.

FIG. 6 sets forth a flowchart of another example method for using pruned neural networks for energy reduction in accordance with some embodiments of the present disclosure.

FIG. 7 sets forth a flowchart of another example method for using pruned neural networks for energy reduction in accordance with some embodiments of the present disclosure.

FIG. 8 sets forth a flowchart of another example method for using pruned neural networks for energy reduction in accordance with some embodiments of the present disclosure.

FIG. 9 sets forth a flowchart of another example method for using pruned neural networks for energy reduction in accordance with some embodiments of the present disclosure.

### DETAILED DESCRIPTION

In some aspects, a method may include: receiving a command to reduce an energy usage of a neural network; transitioning, in response to the command, from using a particular version of the neural network to using a pruned version of the neural network, wherein the pruned version of the neural network comprises a subset of a plurality of layers of the particular version of the neural network; and performing one or more inference operations using the pruned version of the neural network. This provides the technical advantage of reducing overall energy usage of a neural network by instead using a pruned version of the neural network, improving overall resource usage and system utility.

In some aspects, the method may also include transitioning, in response to a command to end reduced energy usage of the neural network, from using the pruned version of the neural network to using the particular version of the neural network. This provides the technical advantage of dynamically switching between different versions of a neural network based on energy usage goals, improving system utility.

In some aspects, this method may also include: monitoring a corresponding activation cost for each layer of the plurality of layers; and generating the pruned version of the neural network to exclude one or more layers of the plurality of layers based on the corresponding activation cost. This provides the technical advantage of allowing for the pruned version of the neural network to be generated based on monitored activation costs, thereby allowing for layers causing more significant energy usage to be removed, improving system utility.

In some aspects, generating the pruned version of the neural network comprises generating the pruned version of the neural network based on a minimum accuracy threshold for the pruned version of the neural network. This provides the technical advantage of allowing for use of the pruned version of the neural network to achieve energy savings while maintaining a desired level of accuracy, improving overall system performance and utility.

In some aspects, generating the pruned version of the neural network based on the minimum accuracy threshold for the pruned version of the neural network comprises generating the pruned version of the neural network based on a plurality of minimum accuracy thresholds for the pruned version of the neural network. This provides the technical advantage of allowing for the pruned neural network to achieve energy savings and desired performance levels across many different types of inference operations or outputs, improving overall system performance and utility.

In some aspects, generating the pruned version of the neural network comprises retraining the pruned version of the neural network. This provides the technical advantage of enabling the pruned version of the neural network to perform inference operations using fewer layers, improving system performance and utility.

In some aspects, generating the pruned version of the neural network comprises generating a plurality of pruned versions of the neural network. This provides the technical advantage of creating different versions of pruned neural networks that may be used in various situations, improving overall system utility.

In some aspects, this method may also include selecting the pruned version of the neural network from a plurality of pruned versions of the neural network. This provides the technical advantage of allowing for a particular pruned version of the neural network to be selected for use based on particular factors, improving overall system utility.

In some aspects, a computer system may include: a processor set; one or more computer-readable storage media; and program instructions stored on the one or more storage media to cause the processor set to perform operations including: receiving a command to reduce an energy usage of a neural network; transitioning, in response to the command, from using a particular version of the neural network to using a pruned version of the neural network, wherein the pruned version of the neural network comprises a subset of a plurality of layers of the particular version of the neural network; and performing one or more inference operations using the pruned version of the neural network. This provides the technical advantage of reducing overall energy usage of a neural network by instead using a pruned version of the neural network, improving overall resource usage and system utility.

In some aspects, these operations may also include transitioning, in response to a command to end reduced energy usage of the neural network, from using the pruned version of the neural network to using the particular version of the neural network. This provides the technical advantage of dynamically switching between different versions of a neural network based on energy usage goals, improving system utility.

In some aspects, these operations may also include: monitoring a corresponding activation cost for each layer of the plurality of layers; and generating the pruned version of the neural network to exclude one or more layers of the plurality of layers based on the corresponding activation cost. This provides the technical advantage of allowing for the pruned version of the neural network to be generated based on monitored activation costs, thereby allowing for layers causing more significant energy usage to be removed, improving system utility.

In some aspects, generating the pruned version of the neural network comprises generating the pruned version of the neural network based on a minimum accuracy threshold for the pruned version of the neural network. This provides the technical advantage of allowing for use of the pruned version of the neural network to achieve energy savings while maintaining a desired level of accuracy, improving overall system performance and utility.

In some aspects, generating the pruned version of the neural network based on the minimum accuracy threshold for the pruned version of the neural network comprises generating the pruned version of the neural network based on a plurality of minimum accuracy thresholds for the pruned version of the neural network. This provides the technical advantage of allowing for the pruned neural network to achieve energy savings and desired performance levels across many different types of inference operations or outputs, improving overall system performance and utility.

In some aspects, generating the pruned version of the neural network comprises retraining the pruned version of the neural network. This provides the technical advantage of enabling the pruned version of the neural network to perform inference operations using fewer layers, improving system performance and utility.

In some aspects, generating the pruned version of the neural network comprises generating a plurality of pruned versions of the neural network. This provides the technical advantage of creating different versions of pruned neural networks that may be used in various situations, improving overall system utility.

In some aspects, these operations may also include selecting the pruned version of the neural network from a plurality of pruned versions of the neural network. This provides the technical advantage of allowing for a particular pruned version of the neural network to be selected for use based on particular factors, improving overall system utility.

In some aspects, a computer program product may include: one or more computer-readable storage media; and program instructions stored on the one or more storage media to perform operations comprising: receiving a command to reduce an energy usage of a neural network; transitioning, in response to the command, from using a particular version of the neural network to using a pruned version of the neural network, wherein the pruned version of the neural network comprises a subset of a plurality of layers of the particular version of the neural network; and performing one or more inference operations using the pruned version of the neural network. This provides the technical advantage of reducing overall energy usage of a neural network by instead using a pruned version of the neural network, improving overall resource usage and system utility.

In some aspects, these operations may also include transitioning, in response to a command to end reduced energy usage of the neural network, from using the pruned version of the neural network to using the particular version of the neural network. This provides the technical advantage of dynamically switching between different versions of a neural network based on energy usage goals, improving system utility.

In some aspects, these operations may also include: monitoring a corresponding activation cost for each layer of the plurality of layers; and generating the pruned version of the neural network to exclude one or more layers of the plurality of layers based on the corresponding activation cost. This provides the technical advantage of allowing for the pruned version of the neural network to be generated based on monitored activation costs, thereby allowing for layers causing more significant energy usage to be removed, improving system utility.

In some aspects, generating the pruned version of the neural network comprises generating the pruned version of the neural network based on a minimum accuracy threshold for the pruned version of the neural network. This provides the technical advantage of allowing for use of the pruned version of the neural network to achieve energy savings while maintaining a desired level of accuracy, improving overall system performance and utility.

In some aspects, generating the pruned version of the neural network based on the minimum accuracy threshold for the pruned version of the neural network comprises generating the pruned version of the neural network based on a plurality of minimum accuracy thresholds for the pruned version of the neural network. This provides the technical advantage of allowing for the pruned neural network to achieve energy savings and desired performance levels across many different types of inference operations or outputs, improving overall system performance and utility.

In some aspects, generating the pruned version of the neural network comprises retraining the pruned version of the neural network. This provides the technical advantage of enabling the pruned version of the neural network to perform inference operations using fewer layers, improving system performance and utility.

In some aspects, generating the pruned version of the neural network comprises generating a plurality of pruned versions of the neural network. This provides the technical advantage of creating different versions of pruned neural networks that may be used in various situations, improving overall system utility.

In some aspects, these operations may also include selecting the pruned version of the neural network from a plurality of pruned versions of the neural network. This provides the technical advantage of allowing for a particular pruned version of the neural network to be selected for use based on particular factors, improving overall system utility.

Inference operations using neural networks are computationally expensive processes. Accordingly, these inference operations may also use significant amounts of energy, resulting in significant carbon output and environmental impact. Each neural network may include multiple layers each with their own set of neurons. When processing input through each layer of the neural network, a subset of neurons in a given layer may activate. Each activated neuron increases the overall energy usage of the neural network in a particular inference operation. Thus, the energy usage of a neural network may vary depending on the activation rate of each layer in the neural network.

Removing layers from a neural network will inherently reduce the overall energy usage of the neural network by virtue of having fewer neurons that can be activated for any given inference operation. However, removing layers from a neural network may also negatively impact the overall accuracy of the neural network. Accordingly, efforts to balance energy usage of a neural network must also consider the impact on accuracy and performance of the neural network.

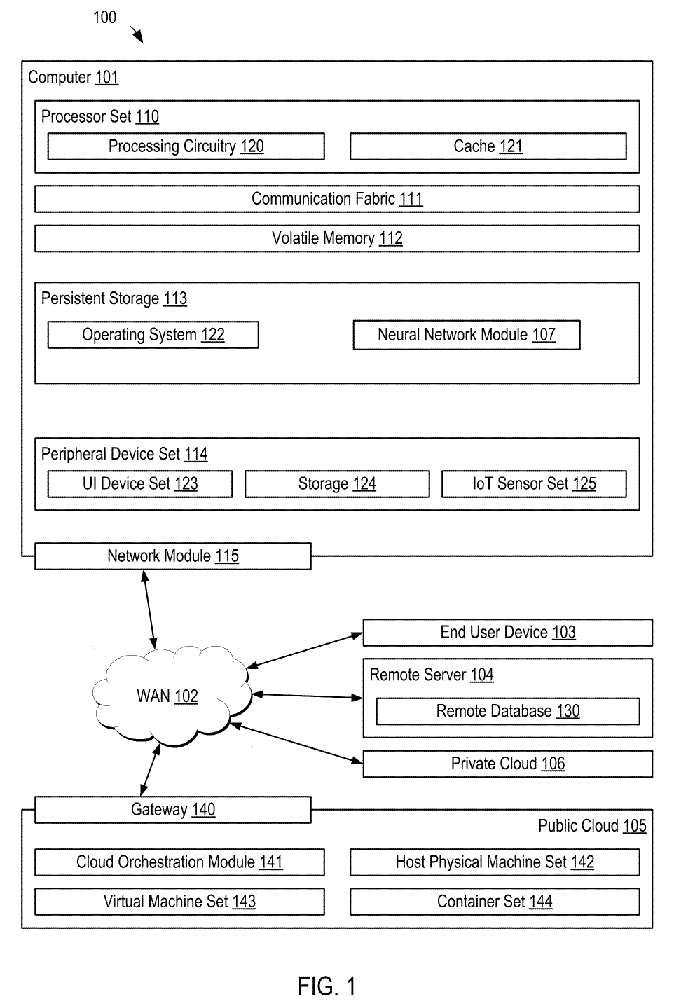

With reference now to FIG. 1, shown is an example computing environment according to aspects of the present disclosure. Computing environment 100 contains an example of an environment for the execution of at least some of the computer code involved in performing the various methods described herein, such as the neural network module 107. In addition to neural network module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and neural network module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in neural network module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in neural network module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

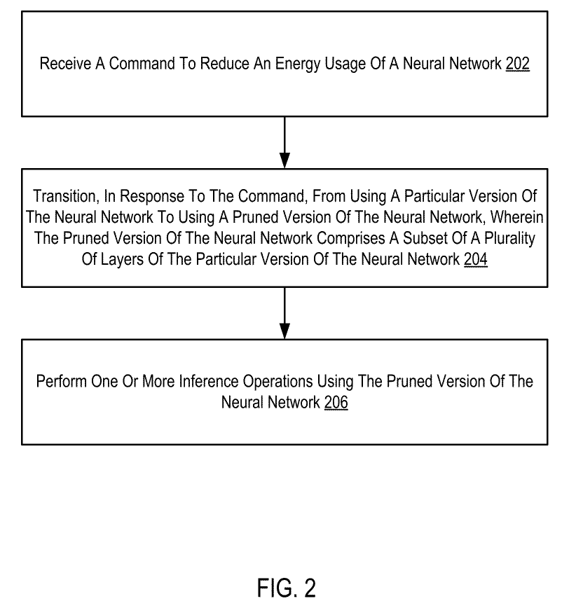

For further explanation, FIG. 2 sets flowchart of an example method of using pruned neural networks for energy reduction in accordance with some embodiments of the present disclosure. The method of FIG. 2 may be performed, for example, by a neural network module 107 of FIG. 1. The method of FIG. 2 includes receiving 202 a command to reduce an energy usage of a neural network. Assume that a system, application, or process uses a neural network to perform some function. For example, assume that a neural network is used to perform some inference operations from which this system, application, or process bases its functions. As described herein, inference operations include operations whereby a neural network generates some output based on some input. Such inference operations may include, for example, predictions, classifications, or other inference operations as can be appreciated. When performing inference operations, neural networks necessarily use some amount of electrical energy. Particularly, as will be described in further detail below, the amount of energy used by a neural network in performing an inference operation may be based on the number of neurons activated through each hidden layer of the neural network.

In some embodiments, the command to reduce an energy usage of the neural network may include a manual or user-provided command. In some embodiments, the command to reduce energy usage of the neural network may be generated in response to some detected event. For example, in some embodiments, the command to reduce energy usage of the neural network may be generated in response to detecting that energy usage of the neural network, or a system including the neural network, has reached or is approaching some threshold. As another example, in some embodiments, the command to reduce energy usage of the neural network may be generated in response to reaching a certain time of day, day of the week, and the like. As a further example, in some embodiments, the command to reduce energy usage of the neural network may be generated in response to monitoring event feeds and detecting some event published by a third party, such as an event related to energy usage in a particular region. Other criteria or events may also be used in generating the received 202 command to reduce an energy usage of the neural network.

The method of FIG. 2 also includes transitioning 204, in response to the command, from using a particular version of the neural network to using a pruned version of the neural network, wherein the pruned version of the neural network comprises a subset of a plurality of layers of the particular version of the neural network. The particular version of the neural network is a version of the neural network in use at the time when the command to reduce energy usage of the neural network was received 202. For example, the particular version of the neural network may include a baseline or initial version of the neural network from which the pruned version of the neural network was generated.

The pruned version of the neural network is similar to this baseline version of the neural network, instead having one or more of its hidden layers removed (e.g., pruned). As the pruned version of the neural network includes fewer hidden layers, and therefore fewer neurons that may be activated, than the baseline version of the neural network, inference operations performed using the pruned version of the neural network necessarily use less energy than the baseline version. Specific approaches for generating the pruned version of the neural network are described in further detail below. Particularly, the pruned version of the neural network may be generated such that the accuracy of the pruned version of the neural network meets or exceeds some minimum accuracy threshold.

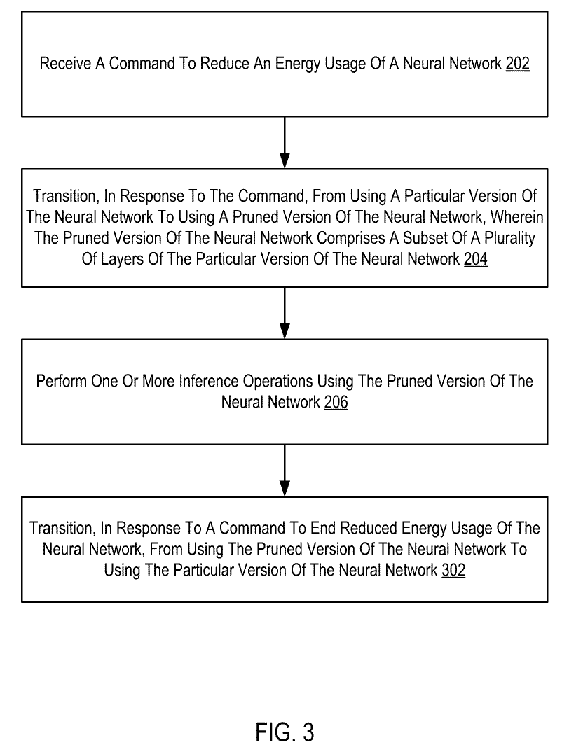

The method of FIG. 3 also includes performing 206 one or more inference operations using the pruned version of the neural network. In other words, after transitioning 204 to use the pruned version of the neural network, subsequently performed 206 inference operations will use the pruned version of the neural network instead of the particular version of the neural network (e.g., the baseline version), thereby using less energy than if they were performed using the baseline version of the neural network. As an example, assume that a system uses a neural network to recognize the alphanumeric characters of license plates as captured in cameras of a toll system. Further assume that, during operation of this system, a message is received from a power utility company indicating that strain on the power grid is approaching untenable levels for maintaining service levels.

In some embodiments, this message may cause a command to reduce energy usage of the neural network to be automatically generated and received 202. In some embodiments, a user receiving this message may automatically enter or provide the command to reduce energy usage of the neural network. In response to this command, the system may transition 204 from using a particular version of the neural network having ninety-five percent accuracy to a pruned version that has fewer layers and seventy-percent accuracy. The system may then use the pruned version of the neural network to perform the license plate recognition process described above, thereby reducing the overall energy usage of the system.

Readers will appreciate that the approaches set forth above allow for systems that rely on neural networks to perform inference operations to reduce their overall energy usage while maintaining an acceptable level of accuracy and service quality. This reduces the overall computational resource and energy usage of inference operations, improving performance and system utility. Moreover, as the pruned version of the neural network includes fewer layers than the particular version of the neural network, the pruned version of the neural network will necessarily produce an output faster than the particular version of the neural network, improving overall latency and performance.

Readers will also appreciate that, although the examples set forth above describe transitioning from using, as the particular version of the neural network, a baseline version of a neural network to using a pruned version of the neural network, these approaches may also be used when transitioning from other versions of the neural network. For example, as will be described in further detail below, a neural network may include potentially many pruned versions that each use different amounts of energy by virtue of including different sets of layers. Accordingly, in some embodiments, the approaches set forth above may be applied to transition from, as the particular version of the neural network, another pruned version of the neural network using more energy to the pruned version of the neural network.

For further explanation, FIG. 3 sets forth a flowchart of another example method of using pruned neural networks for energy reduction in accordance with some embodiments of the present disclosure. The method of FIG. 3 is similar to FIG. 2 in that the method of FIG. 3 also includes: receiving 202 a command to reduce an energy usage of a neural network; transitioning 204, in response to the command, from using a particular version of the neural network to using a pruned version of the neural network, wherein the pruned version of the neural network comprises a subset of a plurality of layers of the particular version of the neural network; and performing 206 one or more inference operations using the pruned version of the neural network.

The method of FIG. 3 differs from FIG. 2 in that the method of FIG. 3 also includes transitioning 302, in response to a command to end reduced energy usage of the neural network, from using the pruned version of the neural network to using the particular version of the neural network. The command to end reduced energy usage of the neural network may be generated and received according to similar approaches as are set forth above with respect to the command to reduce an energy usage of a neural network. For example, the command to end reduced energy usage of the neural network may include a manual or user-provided command, in response to some event, and the like. As another example, in some embodiments, the command to reduce energy usage of the neural network may include a time limit or duration for having reduced energy usage.

In this example, in some embodiments, the command to end reduced energy usage of the neural network may be generated in response to an expiration of this time limit or duration. Other criteria or events may also be used for generating a command to end reduced energy usage of the neural network. Transitioning 302 from using the pruned version of the neural network to using the particular version of the neural network causes subsequently performed inference operations to use the particular version of the neural network instead of the pruned version of the neural network. Thus, inference operations may be performed using the more power-intensive but more accurate particular version of the neural network, allowing for energy usage of the neural network to adapt and adjust over time.

In some embodiments, rather than transitioning between two versions of the neural network (e.g., a particular version and the pruned version), commands may be received that cause the neural network to transition across more than two versions of the neural network. In some embodiments, rather than receiving a command to end reduced energy usage, a command may be received to increase energy usage of the neural network but still maintain some level of reduced energy usage. For example, in some embodiments, a command to reduce energy usage of the neural network may cause the system to transition, from using a baseline version with ninety-percent accuracy, to using a pruned version of the neural network with seventy-percent accuracy. Another command may then be received to increase, but not fully restore, energy usage of the neural network. This may cause the system to transition from using the pruned version of the neural network with seventy-percent accuracy to using another pruned version with eighty-percent accuracy.

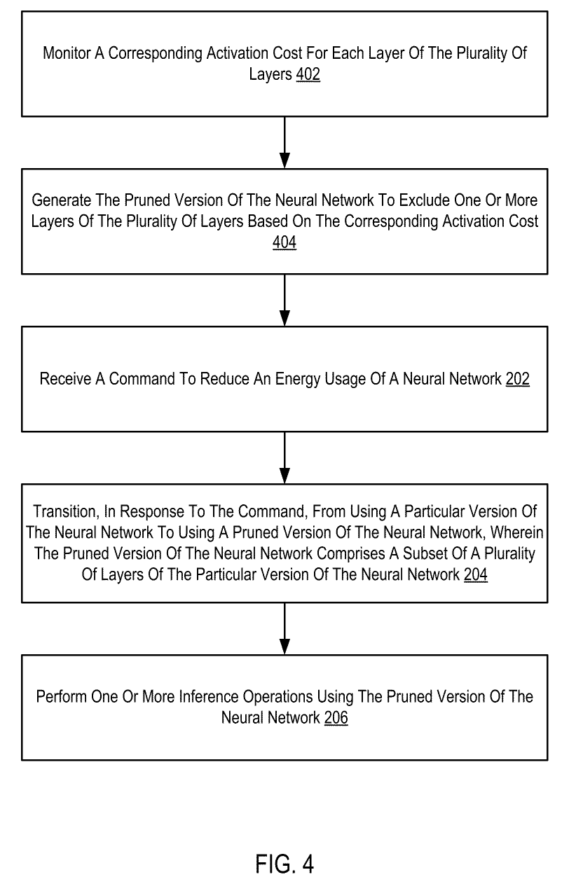

For further explanation, FIG. 4 sets forth a flowchart of another example method of using pruned neural networks for energy reduction in accordance with some embodiments of the present disclosure. The method of FIG. 4 is similar to FIG. 2 in that the method of FIG. 4 also includes: receiving 202 a command to reduce an energy usage of a neural network; transitioning 204, in response to the command, from using a particular version of the neural network to using a pruned version of the neural network, wherein the pruned version of the neural network comprises a subset of a plurality of layers of the particular version of the neural network; and performing 206 one or more inference operations using the pruned version of the neural network.

The method of FIG. 4 differs from FIG. 2 in that the method of FIG. 4 also includes monitoring 402 a corresponding activation cost for each layer of the plurality of layers (e.g., a plurality of activation layers of the particular version of the neural network). In this example, assume that the particular version of the neural network is a baseline version of the neural network. Monitoring 402 a corresponding activation cost for each layer of the plurality of layers may be performed during training of the particular version of the neural network and/or during inference operations performed using the particular version of the neural network after training. An activation cost for a layer of the neural network is a value that corresponds to or is based on a number of neurons activated in that layer. For example, a component activation cost for a layer of the neural network for a given data point (e.g., an input for performing an inference operation and/or a training data sample) may be based on a number of activated neurons for that data point. An activation cost for that layer may then include an aggregate value based on the component activation costs for multiple data costs. For example, the activation cost for a layer may include an average component activation cost for that layer. Other aggregate values may also be used for the activation cost of a layer.

The method of FIG. 4 also includes generating 404 the pruned version of the neural network to exclude one or more layers based on the corresponding activation cost. In other words, the pruned version of the neural network may include identifying and removing, from the baseline version of the neural network, one or more layers based on their respective activation cost. For example, in some embodiments, the removed one or more layers may include one or more layers having the highest corresponding activation cost. As another example, as will be described in further detail below, the removed one or more layers may be based on a minimum accuracy threshold of a pruned version of the neural network. By selectively removing layers with higher activation costs, the removed layers will have the most significant impact on overall energy usage per layer.

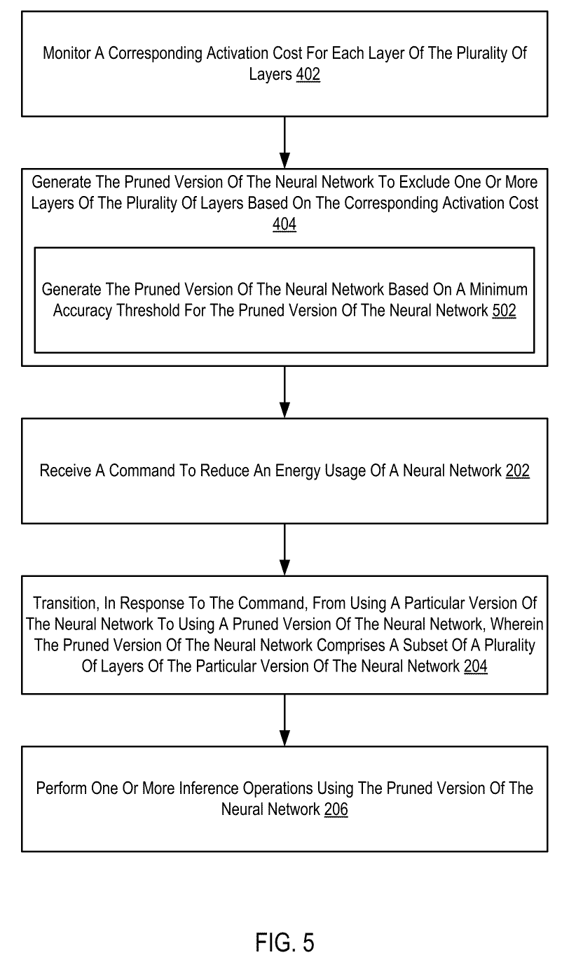

For further explanation, FIG. 5 sets forth a flowchart of another example method of using pruned neural networks for energy reduction in accordance with some embodiments of the present disclosure. The method of FIG. 5 is similar to FIG. 4 in that the method of FIG. 5 also includes: monitoring 402 a corresponding activation cost for each layer of the plurality of layers; generating 404 the pruned version of the neural network to exclude one or more layers based on the corresponding activation cost; receiving 202 a command to reduce an energy usage of a neural network; transitioning 204, in response to the command, from using a particular version of the neural network to using a pruned version of the neural network, wherein the pruned version of the neural network comprises a subset of a plurality of layers of the particular version of the neural network; and performing 206 one or more inference operations using the pruned version of the neural network.

The method of FIG. 5 differs from FIG. 4 in that generating 404 the pruned version of the neural network to exclude one or more layers based on the corresponding activation cost includes generating 502 the pruned version of the neural network based on a minimum accuracy threshold for the pruned version of the neural network. Removing layers from a neural network necessarily has an effect on the overall accuracy of the neural network. Accordingly, in order to ensure that excluding layers from the pruned version of the neural network does not result in an unacceptable accuracy loss, the pruned version of the neural network may be generated 502 so as to exclude the one or more layers while meeting or exceeding the minimum accuracy threshold for the pruned version of the neural network.

As an example, in some embodiments, the activation layers of the particular version of the neural network may be ranked according to their corresponding activation cost. In some embodiments, increasing numbers of the top N highest-ranked activation layers may be removed to generate candidate pruned neural networks. The accuracy of these candidate pruned neural networks may then be tested using some amount of test data. A candidate pruned neural network may then be selected as a pruned neural network for use where that candidate pruned neural network has the highest number of pruned activation layers while meeting or exceeding the minimum accuracy threshold. As another example, in some embodiments, candidate pruned neural networks may be generated by removing different combinations of activation layers, not necessarily just the top N layers based on activation costs. In some embodiments, a pruned neural network may be selected for use as the candidate pruned neural network whose removed layers had the highest activation cost, thereby having the highest predicted energy savings, while meeting or exceeding the minimum accuracy threshold. In other words, in some embodiments, a pruned neural network may be generated by maximizing total predicted energy savings while meeting or exceeding the minimum accuracy threshold. Readers will appreciate that the approaches set forth above for selecting layers for exclusion in a pruned version of the neural network are merely illustrative and that other approaches are also contemplated within the scope of the present disclosure.

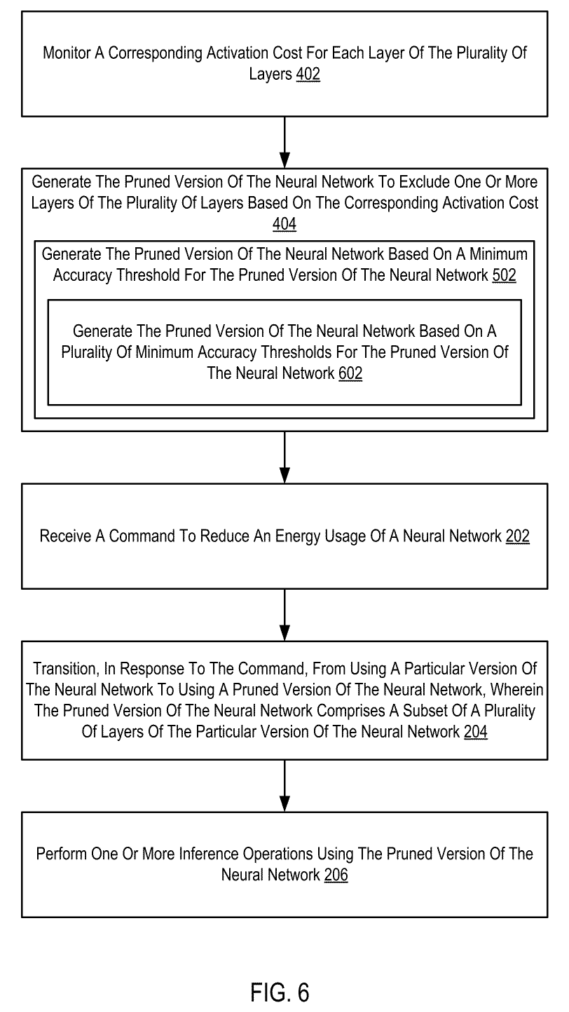

For further explanation, FIG. 6 sets forth a flowchart of another example method of using pruned neural networks for energy reduction in accordance with some embodiments of the present disclosure. The method of FIG. 6 is similar to FIG. 5 in that the method of FIG. 6 also includes: monitoring 402 a corresponding activation cost for each layer of the plurality of layers; generating 404 the pruned version of the neural network to exclude one or more layers based on the corresponding activation cost, including: generating 502 the pruned version of the neural network based on a minimum accuracy threshold for the pruned version of the neural network; receiving 202 a command to reduce an energy usage of a neural network; transitioning 204, in response to the command, from using a particular version of the neural network to using a pruned version of the neural network, wherein the pruned version of the neural network comprises a subset of a plurality of layers of the particular version of the neural network; and performing 206 one or more inference operations using the pruned version of the neural network.

The method of FIG. 6 differs from FIG. 5 in that generating 502 the pruned version of the neural network based on a minimum accuracy threshold for the pruned version of the neural network also includes generating 602 the pruned version of the neural network based on a plurality of minimum accuracy thresholds for the pruned version of the neural network. In some embodiments, a pruned version of a neural network may be generated so as to satisfy multiple minimum accuracy thresholds. In some embodiments, the different minimum accuracy thresholds may correspond to different types of classifications or inference operations that may be performed by the neural network. For example, a neural network may have a first minimum accuracy threshold for identifying different types of animals and a second minimum accuracy threshold for identifying different types of cars. In some embodiments, the different minimum accuracy thresholds may correspond to different particular outputs that may be produced by the neural network, and the like. For example, a neural network may have a first minimum accuracy threshold for detecting cats and a second minimum accuracy threshold for detecting dogs. Readers will appreciate that these minimum accuracy thresholds are merely illustrative and that other minimum accuracy thresholds are also contemplated within the scope of the present disclosure.

Accordingly, the pruned version of the neural network may be generated 602 using similar approaches as are set forth above, instead pruning activation layers so as to satisfy multiple minimum accuracy thresholds. For example, different combinations of activation layers may be removed and the resulting neural networks tested to identify a pruned neural network having the highest predicted energy savings while also satisfying the multiple minimum accuracy thresholds. Readers will appreciate that, as the number of minimum accuracy thresholds increases, identifying a particular combination of removed activation layers that maximizes predicted energy savings while satisfying the minimum accuracy thresholds becomes an increasingly combinatorically complex problem.

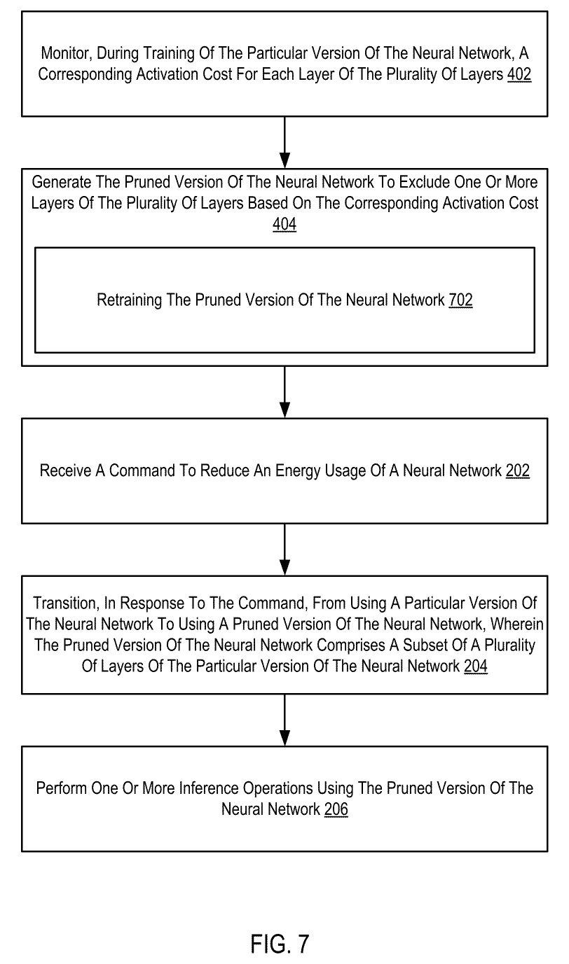

For further explanation, FIG. 7 sets forth a flowchart of another example method of using pruned neural networks for energy reduction in accordance with some embodiments of the present disclosure. The method of FIG. 7 is similar to FIG. 4 in that the method of FIG. 7 also includes: monitoring 402 a corresponding activation cost for each layer of the plurality of layers; generating 404 the pruned version of the neural network to exclude one or more layers based on the corresponding activation cost; receiving 202 a command to reduce an energy usage of a neural network; transitioning 204, in response to the command, from using a particular version of the neural network to using a pruned version of the neural network, wherein the pruned version of the neural network comprises a subset of a plurality of layers of the particular version of the neural network; and performing 206 one or more inference operations using the pruned version of the neural network.

The method of FIG. 7 differs from FIG. 4 in that generating 404 the pruned version of the neural network to exclude one or more layers based on the corresponding activation cost also includes retraining 702 the pruned version of the neural network. In some embodiments, after removing some layers from a neural network, the resulting pruned neural network must effectively be retaught how to process data due to the change in neural connections in the pruned neural network. Accordingly, the pruned version of the neural network is retrained 702 so as to train the pruned version of the neural network to perform inference operations using a reduced set of activation layers. Retraining 702 the pruned version of the neural network may be performed, for example, prior to evaluating an accuracy of the pruned version of the neural network to determine if it satisfies some minimum accuracy threshold.

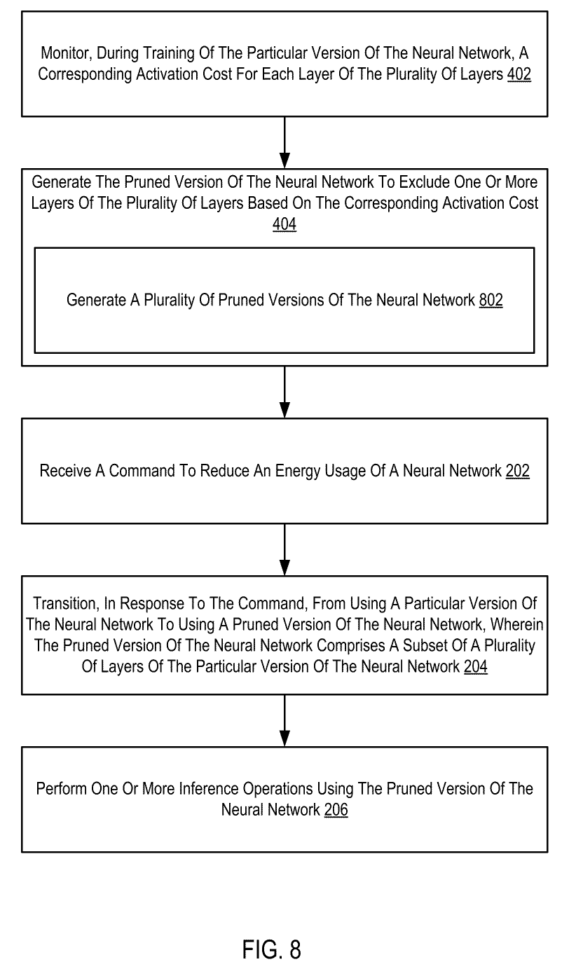

For further explanation, FIG. 8 sets forth a flowchart of another example method of using pruned neural networks for energy reduction in accordance with some embodiments of the present disclosure. The method of FIG. 8 is similar to FIG. 4 in that the method of FIG. 8 also includes: monitoring 402 a corresponding activation cost for each layer of the plurality of layers; generating 404 the pruned version of the neural network to exclude one or more layers based on the corresponding activation cost; receiving 202 a command to reduce an energy usage of a neural network; transitioning 204, in response to the command, from using a particular version of the neural network to using a pruned version of the neural network, wherein the pruned version of the neural network comprises a subset of a plurality of layers of the particular version of the neural network; and performing 206 one or more inference operations using the pruned version of the neural network.

The method of FIG. 8 differs from FIG. 4 in that generating 404 the pruned version of the neural network to exclude one or more layers based on the corresponding activation cost also includes generating 802 a plurality of pruned versions of the neural network. The approaches set forth above describe various approaches for generating a pruned version of a neural network, including selecting layers to exclude, evaluating the accuracy of the resulting pruned version of the neural network, and so forth. In some embodiments, these approaches may also be used for generating multiple pruned versions of a neural network each corresponding to different minimum accuracy thresholds. This may be used, for example, to enable selection of a pruned version of a neural network from multiple pruned versions having different minimum accuracy thresholds and predicted energy savings. For example, for a baseline version of a neural network having ninety-five percent accuracy, a first pruned version may be generated for a seventy-five percent accuracy threshold and the highest predicted energy savings, a second version may be generated for an eighty-five percent accuracy threshold and a lower predicted energy savings, and so forth.

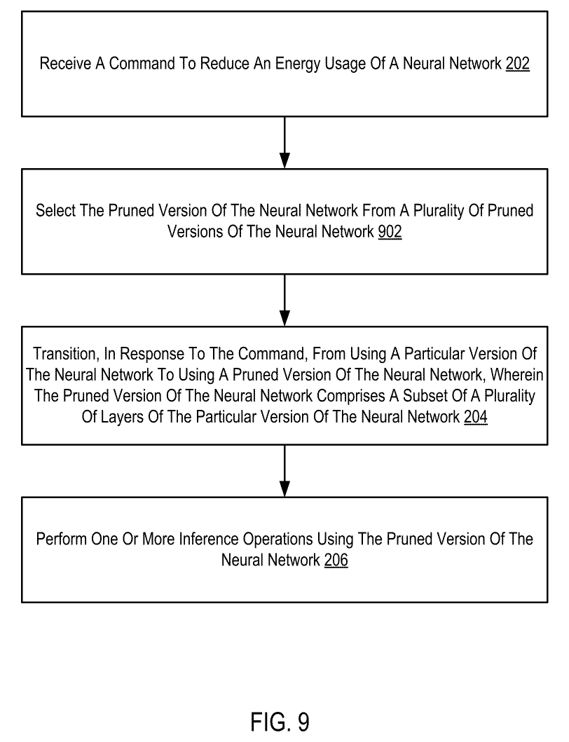

For further explanation, FIG. 9 sets forth a flowchart of another example method of using pruned neural networks for energy reduction in accordance with some embodiments of the present disclosure. The method of FIG. 9 is similar to FIG. 2 in that the method of FIG. 9 also includes: receiving 202 a command to reduce an energy usage of a neural network; transitioning 204, in response to the command, from using a particular version of the neural network to using a pruned version of the neural network, wherein the pruned version of the neural network comprises a subset of a plurality of layers of the particular version of the neural network; and performing 206 one or more inference operations using the pruned version of the neural network.

The method of FIG. 9 differs from FIG. 2 in that the method of FIG. 9 also includes selecting 902 the pruned version of the neural network from a plurality of pruned versions of the neural network. In some embodiments, multiple pruned versions of a neural network may each correspond to different minimum accuracy thresholds and/or predicted energy savings. In some embodiments, a particular pruned version of the neural network may be selected 902 for use based on various criteria. In some embodiments, the command to reduce energy usage of the neural network may indicate a particular pruned version of the neural network to use. In such embodiments, the pruned version of the neural network may then be selected 902 as identified in the command.

In some embodiments, the command to reduce energy usage of the neural network may indicate a minimum accuracy threshold to be satisfied. In such embodiments, the pruned version of the neural network may then be selected 902 as meeting or exceeding the minimum accuracy threshold indicated in the command. In some embodiments, the command to reduce energy usage of the neural network may indicate a particular class or category of energy reduction to achieve (e.g., low energy reduction, medium energy reduction, high energy reduction, and the like). In some embodiments, a particular class or category of energy reduction may be dynamically determined based on various monitored metrics, events, or other criteria. In such embodiments, the pruned version of the neural network may then be selected 902 based on their predicted energy savings and the class or category of energy reduction. Other approaches may also be used for selecting 902 the pruned version of the neural network from a plurality of pruned versions of the neural network.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a command to reduce an energy usage of a neural network;
transitioning, in response to the command, from using a particular version of the neural network to using a pruned version of the neural network, wherein the pruned version of the neural network comprises a subset of a plurality of layers of the particular version of the neural network; and
performing one or more inference operations using the pruned version of the neural network.

2. The method of claim 1, further comprising transitioning, in response to a command to end reduced energy usage of the neural network, from using the pruned version of the neural network to using the particular version of the neural network.

3. The method of claim 1, further comprising:
monitoring a corresponding activation cost for each layer of the plurality of layers; and
generating the pruned version of the neural network to exclude one or more layers of the plurality of layers based on the corresponding activation cost.

4. The method of claim 3, wherein generating the pruned version of the neural network comprises generating the pruned version of the neural network based on a minimum accuracy threshold for the pruned version of the neural network.

5. The method of claim 4, wherein generating the pruned version of the neural network based on the minimum accuracy threshold for the pruned version of the neural network comprises generating the pruned version of the neural network based on a plurality of minimum accuracy thresholds for the pruned version of the neural network.

6. The method of claim 3, wherein generating the pruned version of the neural network comprises retraining the pruned version of the neural network.

7. The method of claim 3, wherein generating the pruned version of the neural network comprises generating a plurality of pruned versions of the neural network.

8. The method of claim 1, wherein the method further comprises selecting the pruned version of the neural network from a plurality of pruned versions of the neural network.

9. A computer system comprising:
a processor set;
one or more computer-readable storage media; and
program instructions stored on the one or more storage media to cause the processor set to perform operations comprising:
receiving a command to reduce an energy usage of a neural network;
transitioning, in response to the command, from using a particular version of the neural network to using a pruned version of the neural network, wherein the pruned version of the neural network comprises a subset of a plurality of layers of the particular version of the neural network; and
performing one or more inference operations using the pruned version of the neural network.

10. The computer system of claim 9, wherein the operations further comprise transitioning, in response to a command to end reduced energy usage of the neural network, from using the pruned version of the neural network to using the particular version of the neural network.

11. The computer system of claim 9, wherein the operations further comprise:
monitoring a corresponding activation cost for each layer of the plurality of layers; and
generating the pruned version of the neural network to exclude one or more layers of the plurality of layers based on the corresponding activation cost.

12. The computer system of claim 11, wherein generating the pruned version of the neural network comprises generating the pruned version of the neural network based on a minimum accuracy threshold for the pruned version of the neural network.

13. The computer system of claim 12, wherein generating the pruned version of the neural network based on the minimum accuracy threshold for the pruned version of the neural network comprises generating the pruned version of the neural network based on a plurality of minimum accuracy thresholds for the pruned version of the neural network.

14. The computer system of claim 11, wherein generating the pruned version of the neural network comprises retraining the pruned version of the neural network.

15. The computer system of claim 11, wherein generating the pruned version of the neural network comprises generating a plurality of pruned versions of the neural network.

16. The computer system of claim 9, wherein the operations further comprise selecting the pruned version of the neural network from a plurality of pruned versions of the neural network.

17. A computer program product comprising:
one or more computer-readable storage media; and
program instructions stored on the one or more storage media to perform operations comprising:
receiving a command to reduce an energy usage of a neural network;
transitioning, in response to the command, from using a particular version of the neural network to using a pruned version of the neural network, wherein the pruned version of the neural network comprises a subset of a plurality of layers of the particular version of the neural network; and
performing one or more inference operations using the pruned version of the neural network.

18. The computer program product of claim 17, wherein the operations further comprise transitioning, in response to a command to end reduced energy usage of the neural network, from using the pruned version of the neural network to using the particular version of the neural network.

19. The computer program product of claim 17, wherein the operations further comprise:
monitoring a corresponding activation cost for each layer of the plurality of layers; and
generating the pruned version of the neural network to exclude one or more layers of the plurality of layers based on the corresponding activation cost.

20. The computer program product of claim 19, wherein generating the pruned version of the neural network comprises generating the pruned version of the neural network based on a minimum accuracy threshold for the pruned version of the neural network.

21. The computer program product of claim 20, wherein generating the pruned version of the neural network based on the minimum accuracy threshold for the pruned version of the neural network comprises generating the pruned version of the neural network based on a plurality of minimum accuracy thresholds for the pruned version of the neural network.

22. The computer program product of claim 19, wherein generating the pruned version of the neural network comprises retraining the pruned version of the neural network.

23. The computer program product of claim 19, wherein generating the pruned version of the neural network comprises generating a plurality of pruned versions of the neural network.

24. The computer program product of claim 17, wherein the operations further comprise selecting the pruned version of the neural network from a plurality of pruned versions of the neural network.
